(19) United States
(12) Patent Application Publication
(10) Pub. No.: US 2010/0004006 A1
(43) Pub. Date: Jan. 7, 2010

(54) METHOD AND SYSTEM FOR PROCESSING CALLS

(75) Inventors: Wen Hai Guo, Beijing (CN); Xiao Pai Bai, Beijing (CN)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/722,408

(22) PCT Filed: Jan. 10, 2006
(86) PCT No.: PCT/US06/00713

§ 371 Date: Jun. 21, 2007

(30) Foreign Application Priority Data
Jan. 12, 2005 (CN) 200510003955.3

(51) Int. Cl. H04W 4/12

(52) U.S. Cl. 455/466

(57) ABSTRACT

A method and system for processing calls is useful for notifying a calling station (205) that a previously non-reachable mobile station (210) has become reachable. The method includes receiving at a gateway switching center (220), in response to the call, an indication that the mobile station (210) is non-reachable. The gateway switching center (220) then transmits to an SMS center (305), in response to the indication that the mobile station (210) is non-reachable, a message comprising parameters of the call. The SMS center (305) then transmits to the mobile station (210), in response to the message comprising parameters of the call, a first SMS message. The first SMS message may identify the calling station (205) and the time of the call. When the mobile station (210) becomes reachable, the SMS center (305) receives an indication that the first SMS message has been received. The SMS center (305) then transmits to the calling station (205), in response to the indication that the first SMS message has been received, a second SMS message indicating that the mobile station (210) is now reachable.

### FIELD OF THE INVENTION

The present invention relates generally to processing calls to mobile stations, and in particular to a method and system for notifying a calling station that a previously non-reachable mobile station has become reachable.

### BACKGROUND OF THE INVENTION

Telephone calls placed to mobile phones may not go through due to a variety of reasons. A called mobile phone may be busy, turned off, out of range of a wireless network, or may be otherwise non-reachable. In such situations, callers often place repetitive additional calls to the called mobile phone until a call goes through and the called mobile phone is answered. Placing such repetitive additional calls is inconvenient and problematic as it wastes the time of callers, who must continual re-key a phone dialing sequence, and because it wastes wireless network resources that must repetively route and process the additional high-priority voice calls until a called phone is answered.

Mobile phone features such as voice mail, call forwarding and other advanced features may reduce the occasions when a caller needs to place such repetitive additional calls to an intended callee. However, such features do not eliminate the above problem. For example, for various reasons callers often decide that they do not want to leave voice mail messages, also callees often forget to turn on or decide not to use features such as call forwarding. In these circumstances callers who urgently want to reach a mobile phone are still required to place repetitive additional calls until the called mobile phone is answered.

The prior art includes complex methods and devices designed to transmit an alert to a caller when a previously non-reachable mobile phone becomes reachable.

However, such prior art methods and devices generally require that substantial hardware changes or additions, such as new interfaces, be made to a wireless network before the alerts can be transmitted. Such modifications or additions to the hardware of wireless networks are generally expensive and are preferably avoided.

### SUMMARY OF THE INVENTION

According to one aspect, the present invention is therefore a method for processing a call from a calling station to a mobile station. The method includes receiving at a gateway switching center, in response to the call, an indication that the mobile station is non-reachable. The gateway switching center then transmits to an SMS center, in response to the indication that the mobile station is non-reachable, a message comprising parameters of the call. The SMS center then transmits to the mobile station, in response to the message comprising parameters of the call, a first SMS message. The first SMS message may identify the calling station and the time of the call. When the mobile station becomes reachable, the SMS center receives an indication that the first SMS message has been received. The SMS center then transmits to the calling station, in response to the indication that the first SMS message has been received, a second SMS message indicating that the mobile station is now reachable. A caller at the calling station thus does not need to waste time repeatedly dialing the mobile station while the mobile station is non-reachable, because the calling station is notified by an SMS message as soon as the mobile station becomes reachable. Further, little or no hardware modifications to a wireless network are required, because the invention employs the SMS messaging infrastructure that is already in place.

According to another aspect, the present invention is a system for processing a call. The system includes a Short Message Service Center (SMS-C) and a Gateway Mobile Switching Center (GMSC). The GMSC is adapted to receive a call setup signal intended to establish a communication channel between a calling station and a mobile station. The GMSC is also adapted to transmit to the SMS-C, in response to an indication that the communication channel was not established because the mobile station is non-reachable, a message comprising parameters of the call. The SMS-C is also adapted to then transmit to the mobile station, in response to the message comprising parameters of the call, a first SMS message to the mobile station, and then to transmit to the calling station, in response to a confirmation that the first SMS message was received by the mobile station, a second SMS message indicating that the mobile station is now reachable.

### BRIEF DESCRIPTION OF THE DRAWINGS

In order that the invention may be readily understood and put into practical effect, reference will now be made to an exemplary embodiment as illustrated with reference to the accompanying drawings, wherein like reference numbers refer to like elements, in which:

FIG. 1 is a schematic diagram illustrating a prior art radio communications device in the form of a radio telephone;

FIG. 2 is a block diagram illustrating components of a typical prior art voice data communications network connecting a calling station to a mobile station;

FIG. 3 is a block diagram illustrating components of a typical prior art Short Message Service (SMS) communications network connecting a calling station to a mobile station;

FIG. 4 is a block diagram illustrating components of a communications network, according to an embodiment of the present invention, including a communications link between a SMS-C and a GMSC; and

FIG. 5 is a general flow diagram illustrating a method of processing a call from a calling station to a non-reachable mobile station according to an embodiment of the present invention.

### DETAILED DESCRIPTION

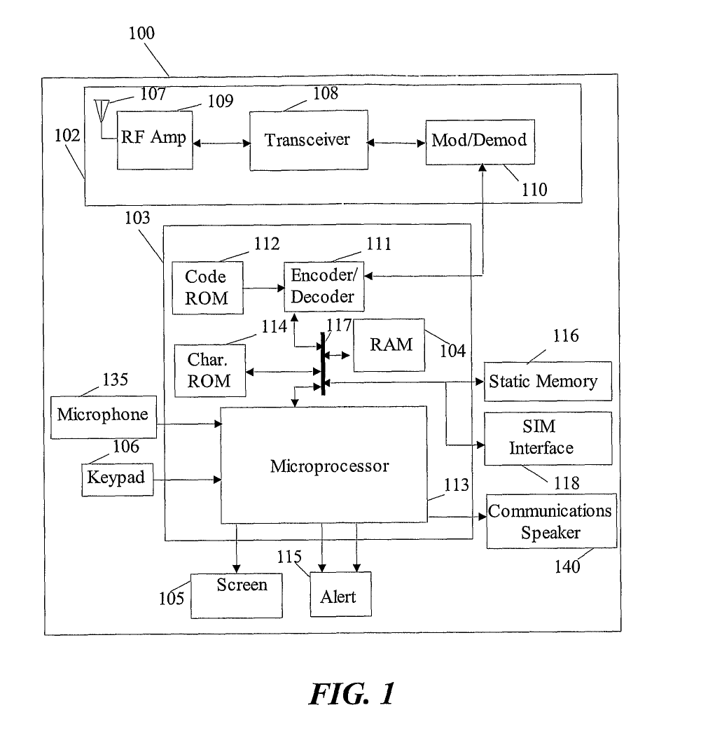

Referring to FIG. 1, there is a schematic diagram illustrating a radio communications device in the form of a radio telephone 100 comprising a radio frequency communications unit 102 coupled to be in communication with a processor 103. The radio telephone 100 also has a keypad 106 and a display screen 105 coupled to be in communication with the processor 103. As will be apparent to a person skilled in the art, screen 105 may be a touch screen thereby making the keypad 106 optional.

The processor 103 includes an encoder/decoder 111 with an associated code Read Only Memory (ROM) 112 storing data for encoding and decoding voice or other signals that may be transmitted or received by the radio telephone 100. The processor 103 also includes a micro-processor 113 coupled, by a common data and address bus 117, to the encoder/decoder 111, a character Read Only Memory (ROM) 114, a Random Access Memory (RAM) 104, static programmable memory 116 and a SIM interface 118. The static programmable memory 116 and a SIM (often called a SIM card) operatively coupled to the SIM interface 118 each can store, amongst other things, selected incoming text messages and a Telephone Number Database TND (phonebook) comprising a number field for telephone numbers and a name field for identifiers associated with one of the numbers in the name field. For instance, one entry in the Telephone Number Database TND may be 91999111111 (entered in the number field) with an associated identifier “Steven C! at work” in the name field. The SIM card and static memory 116 may also store passwords for allowing accessibility to password protected functions on the radio telephone 100.

The micro-processor 113 has ports for coupling to the keypad 106 screen 105 and an alert 115 that typically contains an alert speaker, vibrator motor and associated drivers. Also, micro-processor 113 has ports for coupling to a microphone 135 and communications speaker 140. The character Read only memory 114 stores code for decoding or encoding text messages that may be received by the communications unit 102. In this embodiment the character Read Only Memory 114 also stores operating code (OC) for micro-processor 113 and code for performing functions associated with the radio telephone 100.

The radio frequency communications unit 102 is a combined receiver and transmitter having a common antenna 107. The communications unit 102 has a transceiver 108 coupled to antenna 107 via a radio frequency amplifier 109. The transceiver 108 is also coupled to a combined modulator/demodulator 110 that couples the communications unit 102 to the processor 103.

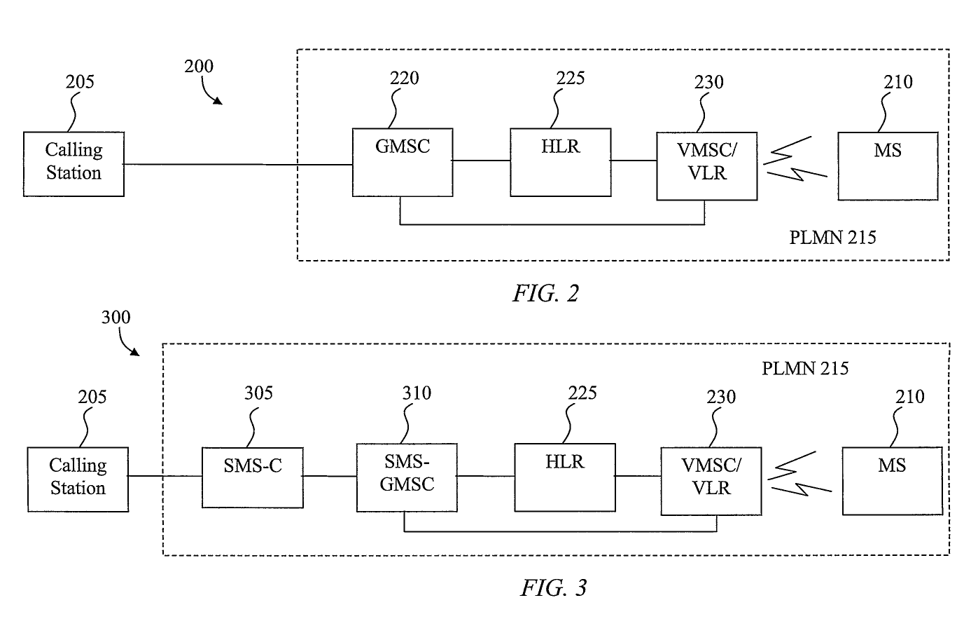

Referring to FIG. 2, there is a block diagram illustrating components of a typical prior art voice data communications network 200 connecting a calling station 205 to a mobile station 210. The calling station 205 may be any type of station capable of connecting to a Public Land Mobile Network (PLMN) 215, such as a mobile phone or a wireline terminal.

To initiate a call from the calling station 205 to the mobile station 210, the calling station 205 first sends an incoming call setup signal, such as an Initial Address Message (IAM), to a Gateway Mobile Switching Center (GMSC) 220 associated with the PLMN 215. If the calling station 205 is another mobile device, the IAM is routed to the GMSC 220 through another PLMN; if the calling station 205 is a wireline terminal then the IAM is routed to the GMSC 220 through a local exchange.

The GMSC 220 then transmits a Mobile Application Part (MAP) to a Home Location Register (HLR) 225 that is associated with the mobile station 210. The HLR 225 includes subscriber data concerning the called mobile station 210, such as the Mobile Subscriber Integrated Service Digital Network (MSISDN) number of the mobile station 210. The HLR 225 also includes the identity of a Visited Mobile Switching Center and corresponding Visitor Location Register (VMSC/VLR) 230 that is providing current service to the mobile station 210. In response to a received MAP, the HLR 225 thus uses the MSISDN to access information about the location of the mobile station 210, and identifies the VMSC/VLR 230 that is currently serving the mobile station 210. The HLR 225 then transmits a MAP to the VMSC/VLR 230 requesting a roaming number of the VMSC/VLR 230. The VMSC/VLR 230 responds by sending a MAP back to the HLR 225, including the roaming number of the VMSC/VLR 230, and the HLR 225 then forwards the roaming number to the GMSC 220. The GMSC 220 is then able to establish a call connection from the calling station 205 to the GMSC 220, then directly to the VMSC/VLR 225. Finally, the VMSC/VLR 25 pages the mobile station 210 and assigns radio channels so that the call can go through between the calling station 205 and the mobile station 210.

Referring to FIG. 3, there is a block diagram illustrating components of a typical prior art Short Message Service (SMS) communications network 300 connecting the calling station 205 to the mobile station 210. For SMS communications, the network 300 includes many of the same components used in the voice data network 200, and further includes some other SMS specific components.

Transmitting an SMS message from the calling station 205 to the mobile station 210 over the network 300 involves the following process. First, the calling station 205 transmits an alphanumeric SMS message to a Short Message Service Center (SMS-C) 305. The SMS-C 305 then encapsulates the message and transmits it in packets to a Short Message Service Gateway Mobile Switching Center (SMS-GMSC) 310. The SMS-GMSC 310 then obtains a roaming number for the VMSC/VLR 230, through the HLR 225, according to a process similar to that described above concerning the voice data network 200.

Using the roaming number of the VMSC/VLR 230, the SMS-GMSC 310 routes the SMS message to the VMSC/VLR 230. The VMSC/VLR 230 then delivers the SMS message to the mobile station 210 using a wireless data channel such as a Slow Associated Control Channel (SACCH). The mobile station 210 stores the SMS message in, for example, a local SIM card from where it can be retrieved for viewing by a user. Finally, after a mobile station 210 successfully receives an SMS message, it transmits a successful delivery report to the VMSC/VLR 230, which report is then passed through the SMS-GMSC 310 to the SMS-C 305.

A mobile station 210 may be non-reachable for various reasons. For example it may be turned off, out of range of a PLMN 215, or for some other reason cannot establish communications with a VMSC/VLR 230. In such situations where a mobile station 210 is non-reachable, both incoming voice call setup signals and SMS messages will fail to be delivered.

However, voice data communications networks 200 and SMS communications networks 300 handle failed deliveries differently. In both voice networks 200 and SMS networks 300, when a VMSC/VLR 230 determines that a mobile station 210 is non-reachable, the VMSC/VLR 230 sends an “absent subscriber” code to the appropriate HLR 225. In a voice network 200, the HLR 225 then transmits the “absent subscriber” code to the GMSC 220 and the call is terminated. In an SMS network 300, the HLR 225 transmits the “absent subscriber” code to the SMS-GMSC 220 which in turn transmits the “absent subscriber” code to the SMS-C 305. However, in an SMS network 300, the SMS-C 305 stores the failed SMS message and then regularly attempts to resend the SMS message until a delivery period expires, the SMS message is aborted, or the message is successfully delivered. Thus an important feature of an SMS network 300 is that, following a failed delivery of an SMS message, the network 300 will regularly query a non-reachable mobile station 210 for a given time period and, if the mobile station 210 becomes reachable during that time period, successfully deliver the SMS message and transmit back to a sending SMS-C 305 a successful delivery report. As described below, the present invention employs that feature of SMS networks 300 to inform a caller on a voice communication network 200 when a previously non-reachable mobile station 210 becomes reachable. The caller will thus know that he or she should now be able to successfully establish a voice call communication channel with the mobile station 210

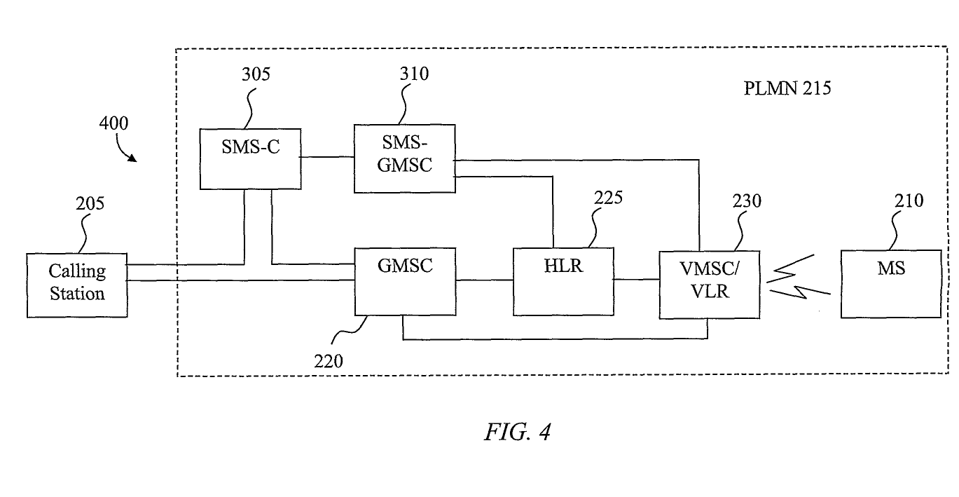

Referring to FIG. 4, there is a block diagram illustrating components of a communications network 400, according to an embodiment of the present invention, including a communications link between a SMS-C 305 and a GMSC 220. As in a prior art voice communications network 300, when a voice call from a calling station 205 to a mobile station 210 does not go through because the mobile station 210 is non-reachable, an “absent subscriber” code is delivered to the GMSC 220. However, according to the prior art, the calling station 205 is simply informed that the call could not go through because the mobile station 210 is non-reachable, and the caller is provided with no further updates concerning a reachable/non-reachable status of the mobile station 210. If the caller urgently wants to reach the user of the mobile station 210, the caller must call again, or redial, the mobile station 210—and must continue such redialing until the mobile station becomes reachable. Such repetitive redialing wastes the time of the caller and also wastes network bandwidth resources that are consumed by the PLMN 215 when it repeatedly attempts to contact the mobile station 210 according to the process described above in relation to FIG. 2.

The present invention eliminates the need for a calling station 205 to repeatedly redial a non-reachable mobile station 210. According to an embodiment of the present invention based on the network 400, when a call does not go through and the GMSC 220 receives an “absent subscriber” code from the BLR 225, the GMSC 220 informs the calling station 205 that the mobile station 210 is non-reachable.

However, the GMSC 220 then also transmits a message comprising parameters of the call to a local SMS-C 305, indicating that a voice call from the calling station 205 to the mobile station 210 did not go through.

Those skilled in the art will recognize that the message from the GMSC 220 to the local SMS-C 305 comprising parameters of the call can be in various formats, such as an SMS message, and may include fields such as a message type, a caller number, a called number, a timestamp, and a text string for use in the second SMS message.

After receiving the message comprising parameters of the call, the SMS-C 305 attempts to transmit a first “missed call” SMS message to the mobile station 210. The text of the “missed call” SMS message to the mobile station 210 may state the number of the calling station 205 and the time of the missed call, for example: “139XXXX4473 called at 18:28, 6/11/2004.”

Because the mobile station 210 is initially non-reachable, the first delivery attempt of the “missed call” SMS message to the mobile station 210 will likely fail, and the SMS-C 305 will also receive an “absent subscriber” code from the HLR 225. However, according to the standard procedures described above, the SMS-C 305 will regularly resend the “missed call” SMS message. Eventually, when the mobile station 210 becomes reachable, the “missed call” SMS message will be delivered and a successful delivery report will be transmitted back to the SMS-C 305. The SMS-C 305 then immediately transmits a second SMS message, which is addressed to the calling station 205. The second SMS message informs the calling station 205 that the mobile station 210 is now reachable. For example, the second SMS message may include the following text: “139XXXX6529 can be reached now”, where the number “139XXXX6529” is the telephone number of the mobile station 210.

Therefore, according to the present invention, a calling station 205 needs to attempt to call a non-reachable mobile station 210 only once. The calling station 205 then simply waits to receive the second SMS message from the SMS-C 305, which states that the mobile station 210 is reachable. The calling station 205 then redials the number of the mobile station 210 only once—with reasonable confidence that the call will go through because the mobile station 210 has just recently become reachable.

Those skilled in the art will also recognize that little or no hardware modifications are required to prior art networks 200, 300 in order to create a network 400 over which the present invention can be performed. That is because connections between SMS-Cs and GMSCs either already exist or are easily established.

In addition to providing added convenience for network users, the present invention can increase revenues for network operators. For example, network operators can charge a standard subscription fee for access to the services of the present invention. Alternatively, network operators can charge a per-use SMS fee for each SMS message sent to either a calling station 205 or a mobile station 210 in accordance with the present invention.

Calling stations 205 that are not subscribed to an SMS notification service according to the present invention, may continue to repeatedly dial non-reachable mobile stations 210. Thus, according to a further embodiment of the present invention, the SMS-C 305 may be directed by the GMSC 220 to send multiple “missed call” SMS messages to the non-reachable mobile station 210—i.e., one “missed call” SMS message for each time the calling station 205 attempts unsuccessfully to reach the non-reachable mobile station 210. However, rather than continuing to resend such multiple “missed call” SMS messages to the mobile station 210, the SMS-C 305 can be programmed to count the number of unsuccessful calls from a particular calling station 205. The SMS-C 305 then transmits only two “missed call” SMS messages to the mobile station 210, the first of which may be similar to the example described above (e.g., “139XXXX4473 called at 18:28, 6/11/2004”) and the second of which message summarizes details of the plurality of previous unsuccessful calls. For example, a second “missed call” SMS message may include the text: “139XXXX4473 called you three times; last call at 18:28, 6/11/2004.”

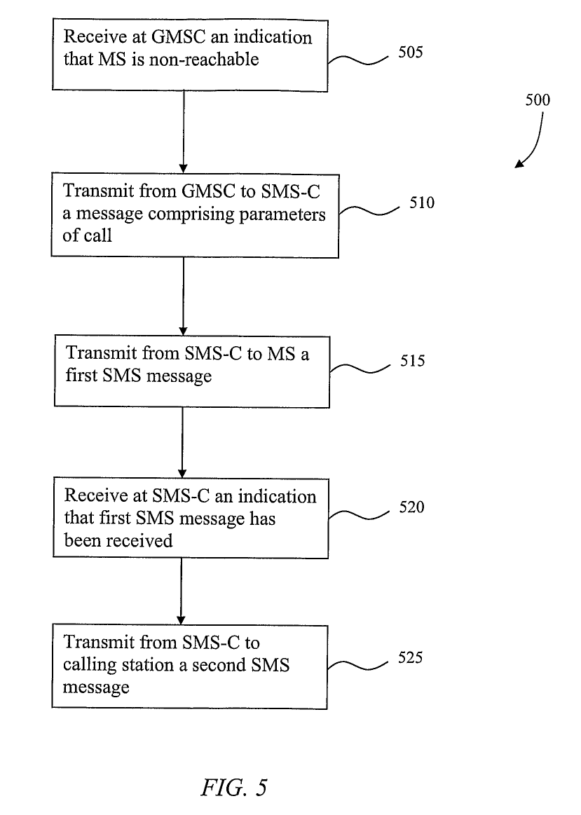

Referring to FIG. 5, there is a general flow diagram illustrating a method 500 of processing a call from a calling station 205 to a non-reachable mobile station 210 according to an embodiment of the present invention. First, at step 505, in response to the call, a GMSC 220 receives an indication that the mobile station 210 is non-reachable. Next, at step 510, in response to the indication that the mobile station 210 is non-reachable, the GMSC 220 transmits to an SMS-C 305 a message comprising parameters of the call. The message comprising parameters of the call may include fields such as the calling number, the called number, a time stamp, etc. At step 515, in response to the message comprising parameters of the call, the SMS-C 305 transmits to the mobile station 210 a first SMS message. The first SMS message may include any information, but will generally identify the calling station 205 and the time of the call. At step 520, after the mobile station 210 becomes reachable, the SMS-C 305 receives an indication that the first SMS message has been received.

Finally, at step 525, in response to the indication that the first SMS message has been received, the SMS-C 305 transmits to the calling station 205 a second SMS message indicating that the mobile station 210 is now reachable.

In summary, the present invention is an improved method and system for notifying a calling station that a previously non-reachable mobile station 210 has become reachable. Because a calling station 205 is notified immediately after a mobile station 210 becomes reachable (e.g., the mobile station 210 is turned on or otherwise becomes connected to a PLMN 215), there is no need for a caller to redial a non-reachable mobile station 210 until the caller receives the notification. The present invention thus prevents wasted time spent in redialing non-reachable phones, and adds significant convenience for callers. Also, called parties can benefit from an embodiment of the present invention that includes notifying a called mobile station 210 of the identity of parties who tried to reach the mobile station 210 when it was non-reachable. A further advantage of the present invention is that it requires little or no hardware changes to existing public land mobile networks; rather, straight forward software modifications to existing components of a PLMN 215 is all that is required to implement the invention.

The above detailed description provides an exemplary embodiment only, and is not intended to limit the scope, applicability, or configuration of the present invention. Rather, the detailed description of the exemplary embodiment provides those skilled in the art with an enabling description for implementing the exemplary embodiment of the invention. It should be understood that various changes can be made in the function and arrangement of elements and steps without departing from the spirit and scope of the invention as set forth in the appended claims.

We claim:

1. A method for processing a call from a calling station to a mobile station, the method comprising the steps of:
receiving at a gateway switching center, in response to the call, an indication that the mobile station is non-reachable;
transmitting from the gateway switching center to an SMS center, in response to the indication that the mobile station is non-reachable, a message comprising parameters of the call;
transmitting from the SMS center to the mobile station, in response to the message comprising parameters of the call, a first SMS message;
receiving at the SMS center an indication that the first SMS message has been received; and
transmitting from the SMS center to the calling station, in response to the indication that the first SMS message has been received, a second SMS message indicating that the mobile station is now reachable.

2. The method of claim 1, wherein in the first SMS message identifies the calling station and the time of the call.

3. The method of claim 1, wherein the message comprising parameters of the call includes fields selected from the group consisting of a message type, a caller number, a called number, a timestamp, and a text string for use in the second SMS message.

4. The method of claim 1, wherein the indication that the mobile station is non-reachable is a response from a Home Location Register (HLR) having a value “absent subscriber.”

5. The method of claim 1, wherein the calling station is selected from the group consisting of digital phones, mobile phones, personal digital assistants, and personal computers.

6. The method of claim 1, further comprising the step of connecting a second call from the calling station to the mobile station.

7. The method of claim 1, wherein an SMS message fee is charged to the calling station.

8. The method of claim 1, wherein the first SMS message identifies a plurality of previous calls from the calling station to the mobile station.

9. A system for processing a call, comprising:
a Short Message Service Center (SMS-C); and
a Gateway Mobile Switching Center (GMSC) adapted to receive a call setup signal intended to establish a communication channel between a calling station and a mobile station, and further adapted to transmit to the SMS-C, in response to an indication that the communication channel was not established because the mobile station is non-reachable, a message comprising parameters of the call;
wherein the SMS-C is adapted to transmit to the mobile station, in response to the message comprising parameters of the call, a first SMS message to the mobile station, and the SMS-C is further adapted to transmit to the calling station, in response to a confirmation that the first SMS message was received by the mobile station, a second SMS message indicating that the mobile station is now reachable.

10. The system of claim 9, wherein in the first SMS message identifies the calling station and the time of the call.

11. The system of claim 9, wherein the message comprising parameters of the call includes fields selected from the group consisting of a message type, a caller number, a called number, a timestamp, and a text string for use in the second SMS message.

12. The system of claim 9, wherein the indication that the mobile station is non-reachable is a response from a Home Location Register (HLR) having a value “absent subscriber.”

13. The system of claim 9, wherein the calling station is selected from the group consisting of digital phones, mobile phones, personal digital assistants, and personal computers.

14. The system of claim 9, wherein the SMS-C is adapted to charge an SMS message fee to the calling station.

15. The system of claim 9, wherein the first SMS message identifies a plurality of previous calls from the calling station to the mobile station.
